(19) United States
(12) Patent Application Publication
(10) Pub. No.: US 2022/0000301 A1
(43) Pub. Date: Jan. 6, 2022

(54) MULTIFUNCTIONAL COOKER

(71) Applicant: GUANGDONG SHUNDE OUNING TECHNOLOGY ELECTRICAL APPLIANCE CO., LTD., Guangdong (CN)

(72) Inventors: Zhenxiong HUANG, Guangdong (CN); Yun YANG, Guangdong (CN)

(73) Assignee: GUANGDONG SHUNDE OUNING TECHNOLOGY ELECTRICAL APPLIANCE CO., LTD., Guangdong (CN)

(21) Appl. No.: 17/295,048

(22) PCT Filed: Dec. 6, 2018
(86) PCT No.: PCT/CN2018/119570

§ 371 Date: May 19, 2021

(30) Foreign Application Priority Data
Nov. 19, 2018 (CN) 201821904094.5

(51) Int. Cl. A47J 27/086; A47J 37/06

(52) U.S. Cl. CPC A47J 27/086; A47J 37/0641

(57) ABSTRACT

The present invention relates to a cookware, and in particular, relates to a multifunctional cooker. The multifunctional cooker comprises a cooker body and cooker covers, wherein the multifunctional cooker is provided with at least two cooker covers, at least one cooker cover is provided with an air fryer assembly, at least one cooker cover is provided with a pressure cooker assembly, and at least one cooker cover is connected with the cooker body. The present invention integrates the functions of pressure cooking and air baking, thereby realizing the switch between pressure cooker function and air fryer function and realizing the purpose of one cooker with multiple functions.

### BACKGROUND

### Technical Field

The present invention relates to a cookware, and in particular, relates to a multifunctional cooker.

### Description of Related Art

Existing consumers are constantly pursuing healthy cooking, and thus constantly improving the cooking for a diet full of color, aroma and taste. Pressure cooking has pressure penetration and can meet certain temperature requirements. In the market, products with this function are generally considered to realize healthy and nutritious cooking. However, after pressure cooking, the surface color and taste of the food may not reach feeling of the crispy and delicious taste. If it can also be baked, the food will be full of color, aroma and taste, with qualities of health and nutrition, and the food will be popular with consumers and has huge market potential. The existing pressure cooker only has the function of pressure cooking. Similarly, the existing air fryer only has the function of baking food by hot air. At present, there are no products which have cooking functions of both pressure cooking and air baking. The present invention integrates the functions of pressure cooking and air baking, and realizes two functions on one product. It can not only realize functions of pressure cooking for rice, porridge, soup and other functions, but also use the product to realize functions of frying potato chips, chicken wings, beef, and spareribs and other functions. It may also use the product to pressure cook and then bake and fry the food, so that the pressure cooking and the baking are used as two cooking stages for the same food, thereby realizing the purpose of one cooker with multiple functions.

### SUMMARY

To overcome at least one defect of the above-mentioned prior art, the present invention provides a multifunctional cooker which integrates functions of pressure cooker and air fryer, realizing switch between pressure cooker function and air fryer function and realizing the purpose of one cooker with multiple functions.

In order to solve the above technical problems, the technical solution adopted by the present invention is as follows: a multifunctional cooker, comprising a cooker body and cooker covers, wherein the multifunctional cooker is provided with at least two cooker covers, at least one cooker cover is provided with an air fryer assembly, at least one cooker cover is provided with a pressure cooker assembly, and at least one cooker cover is connected with the cooker body.

In the present technical solution, the multifunctional cooker is provided with at least two cooker covers, and the cooker cover provided with the air fryer assembly is used to be cooperated with the cooker body, the air fryer function is realized by the cooker cover provided with the air fryer assembly. The cooker cover provided with the pressure cooker assembly is used to be cooperated with the cooker body, the pressure cooker function is realized by the provided pressure cooker assembly. At at least one of the at least two cooker covers is connected with the cooker body. After the cooker cover connected to the cooker body is turned over and opened with respect to the cooker body, other cooker cover is used to be cooperated with the cooker body to realize the closure of the cooker body. The assemblies provided on the cooker cover act on a space defined by the cooker cover and the cooker body. Through different assemblies provided on different cooker covers, the function switch of the multifunctional cooker between the air fryer function and the pressure cooker function is realized and the purpose of one cooker with multiple functions is realized.

In one embodiment, at least one cooker cover is arranged separately with respect to the cooker body. At least one cooker cover is connected with the cooker body, and at least one cooker cover is arranged separately with respect to the cooker body. The cooker cover connected with the cooker body and the cooker cover arranged separately with respect to the cooker body is cooperated with the cooker body respectively. Through different assemblies provided on different cooker covers, the function switch of the multifunctional cooker between the air fryer function and the pressure cooker function is realized and the purpose of one cooker with multiple functions is realized.

In one embodiment, the multifunctional cooker is provided with two cooker covers. One cooker cover is provided with the air fryer assembly, and another cooker cover is provided with the pressure cooker assembly. The multifunctional cooker is provided with two cooker covers, and either of the two cooker covers is selected to be connected with the cooker body. The cooker cover provided with the pressure cooker assembly is connected with the cooker body to realize the pressure cooker function. The cooker cover provided with the air fryer assembly is connected with the cooker body to realize the air fryer function. And the function switch of the multifunctional cooker between the air fryer function and the pressure cooker function is realized and the purpose of one cooker with multiple functions is realized.

Preferably, the cooker cover provided with the air fryer assembly is connected with the cooker body, and the cooker cover provided with the pressure cooker assembly is arranged separately with respect to the cooker body. The cooker body is connected with the cooker cover provided with the air fryer assembly, and meanwhile is equipped with the cooker cover which is arranged separately and provided with the pressure cooker assembly. The two cooker covers are cooperated with cooker body respectively and act on the space defined by the cooker cover and the cooker body, and the function switch of the multifunctional cooker between the air fryer function and the pressure cooker function is realized.

Preferably, the cooker cover provided with the pressure cooker assembly is connected with the cooker body, and the cooker cover provided with the air fryer assembly is arranged separately with respect to the cooker body. The cooker body is connected with the cooker cover provided with the pressure cooker assembly, and meanwhile is equipped with the cooker cover which is arranged separately and provided with the air fryer assembly. The two cooker covers are cooperated with cooker body respectively and act on the space defined by the cooker cover and the cooker body, and the function switch of the multifunctional cooker between the air fryer function and the pressure cooker function is realized.

In one embodiment, the cooker cover is rotatably connected with the cooker body by a hinge assembly, and the hinge assembly comprises a hinge cover connected with the cooker cover. The hinge cover is connected with a hinge mount by a hinge pin, and the hinge mount is connected with the cooker body. The hinge assembly is connected with the cooker cover and the cooker body to realize a hinged connection between the cooker cover and the cooker body. The hinge assembly comprises the hinge cover, the hinge mount and the hinge pin. The hinge cover is rotatably connected with the hinge mount by the hinge pin. The hinge mount and the hinge pin are connected with the cooker cover and the cooker body respectively and a rotatable connection between the cooker cover and the cooker body is realized.

In one embodiment, the air fryer assembly comprises a heating assembly and a wind power assembly, and the heating assembly is cooperated with the wind power assembly to act on a space defined by the cooker cover and the cooker body. A heat insulation member is provided between the heating assembly and the wind power assembly. The heating assembly is a heating tube and the wind power assembly comprises a drive member and a fan. The heat insulation member isolates the heating assembly and wind power assembly, so as to prevent the high temperature of the heating assembly from damaging the wind power assembly. The heating assembly and the wind power assembly interact with each to realize the flowing of hot air in the space defined by the cooker cover and the cooker body, and realize the air fryer function. The fan rotates under the action of the driving member and acts on the heating tube to realize the flowing of hot air, and the baking for the goods is realized by the flowing of hot air.

In one embodiment, the pressure cooker assembly is provided with a pressure limiting valve assembly and a seal housing which are connected with the cooker cover. The cooker body is sealed by the sealing housing when the cooker cover is connected with the cooker body. A pressure is released by the pressure limiting valve assembly when the pressure in the cooker body exceeds a threshold value. The pressure limiting valve assembly comprises an exhaust pipe, a protective casing and a valve. The exhaust pipe penetrates the cooker cover, and both ends of the exhaust pipe are connected with the protective casing and the valve respectively. The pressure cooker assembly is provided with the pressure limiting valve assembly and the seal housing, and the pressure limiting valve assembly is used for controlling the the pressure in the cooker body and releasing the pressure when the pressure in the cooker body exceeds the threshold value, and the seal housing realizes the sealed connection between the cooker cover and the cooker body. The exhaust pipe penetrates the cooker cover to realize the communication between an inside and an outside of the cooker body, and the pressure in the cooker body is adjusted through the exhaust pipe and the valve. The protective casing is connected to one end of the exhaust pipe to avoid blockage of the exhaust pipe.

In one embodiment, the cooker body is provided with a base assembly comprising a heating base and a control module. The heating base is controlled by the control module, and the base assembly is cooperated with the cooker cover, so as to realize the heating function. The heating base is controlled by the control module to heat an inner pot, and the cooker cover provided with the pressure cooker assembly is cooperated with the cooker body to realize the pressure cooker function.

In one embodiment, the cooker body is provided with an inner pot and a frying basket. The inner pot is cooperated with the cooker cover provided with the pressure cooker assembly, and the frying basket is cooperated with the cooker cover provided with the air fryer assembly. The inner pot and the frying basket are respectively used in the pressure cooker and the air fryer, and the switch between the functions of the multifunctional cooker is realized through the cooperation between the inner pot or the frying basket and the cooker covers provided with different assemblies.

Compared with the prior art, the present invention has the following characteristics:

1. In the technical solution of the present application, since one of at least two cooker covers is connected with the cooker body, when changing the cooker cover connected with the cooker body due to the need for switching the function of the cooker, the cooker cover connected with the cooker body is only needed to be turned over and opened and does not need to be removed and placed on another place, and another cooker cover arranged separately may be covered on the cooker body, which is very convenient to be used.

2. Through the cooperation between the cooker covers with different assemblies and the cooker body, the switch of the multifunctional cooker between pressure cooker function and air fryer function is realized and the purpose of one cooker with multiple functions is realized.

3. Through the switch of the cooker covers cooperated with the cooker body, the switch of the functions of the multifunctional cooker is realized, the problem of the single function of the existing air fryer and the existing pressure cooker is solved, and the practicality of the multifunctional cooker is improved.

### BRIEF DESCRIPTION OF THE DRAWINGS

FIG. 1 is a schematic structural view of a multifunctional cooker in an embodiment of the present invention when it realizes the pressure cooker function.

FIG. 2 is a schematic structural view of a multifunctional cooker in the embodiment of the present invention when it realizes the air fryer function.

FIG. 3 is schematic structural view shows a rotatable connection between the cooker cover and the cooker body in the embodiment of the present invention.

FIG. 4 is a schematic view of a multifunctional cooker in an embodiment of the present invention when it realizes the pressure cooker function.

FIG. 5 is a cross-sectional view of the structure of a multifunctional cooker in the embodiment of the present invention when it realizes the pressure cooker function.

FIG. 6 is a schematic structural view of a pressure limiting valve assembly in the embodiment of the present invention.

### DESCRIPTION OF THE EMBODIMENTS

The accompanying drawings are only for exemplary description, and shall not be construed as limiting the present invention. For ease of description for the embodiments, some parts in the accompanying drawings may be omitted, scaled up or scaled down, which do not represent the practical dimensions of the product. For a person skilled in the art, it is understandable that some commonly known structures may be omitted in accompanying drawings and that their descriptions may be omitted. The positional relationship described in the accompanying drawings is for illustrative purposes only, and cannot be understood as limiting to the present invention.

The same or similar reference numerals in the drawings of the embodiments of the present invention correspond to the same or similar components; in the description of the present invention, it should be understood that if there are the terms “upper”, “lower”, “left”, “right”, and other terms which indicate the orientation or positional relationship based on the orientation or positional relationship that shown in the drawings, they are only for the convenience of describing the present invention and simplifying the description, rather than indicating or implying that the device or element referred to must have a specific orientation and must be constructed and operated in a specific position. So the terms describing the positional relationship in the drawings are only used for exemplary description, and cannot be understood as a limitation of the present patent. For those of ordinary skill in the art, the specific meaning of the above terms can be understood according to the specific situation.

### Embodiment 1

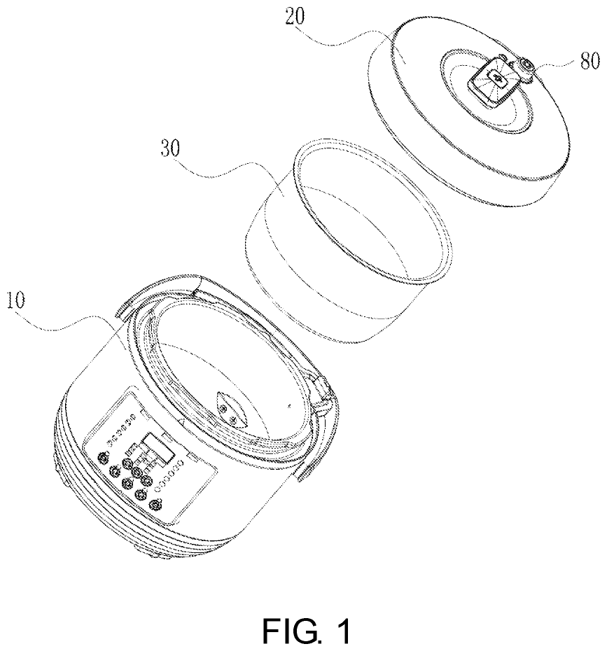

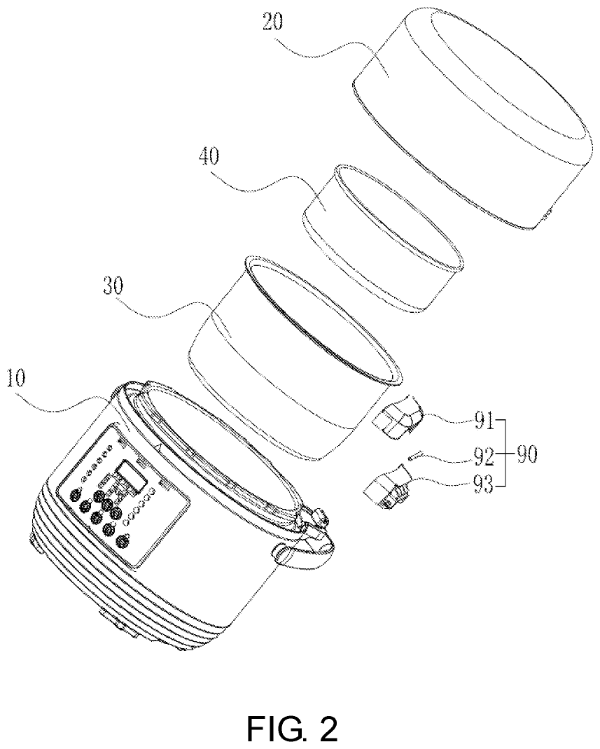

As shown in FIG. 1 and FIG. 2, the present invention provides a multifunctional cooker comprising a cooker body 10 and cooker covers 20 cooperated with the cooker body 10. The multifunctional cooker is provided with at least two cooker covers 20. At least one cooker cover 20 is provided with a pressure cooker assembly. At least one cooker cover 20 is connected with the cooker body 10, and meanwhile at least one cooker cover 20 is arranged separately with respect to the cooker body 10. After the cooker cover 20 connected to the cooker body 10 is opened with respect to the cooker body 10, the cooker cover 20 arranged separately with respect to the cooker body 10 is connected with the cooker body. Different cooker covers 20 provided with different assemblies are cooperated with cooker body 10 to realize the switch of the function of the multifunctional cooker.

At least one of the cooker covers 20 is provided with an air fryer assembly, and at least one of the cooker covers 20 is provided with a pressure cooker assembly. The cooker cover 20 provided with the air fryer assembly is connected with the cooker body 10, and the air fryer function is realized by the air fryer assembly.

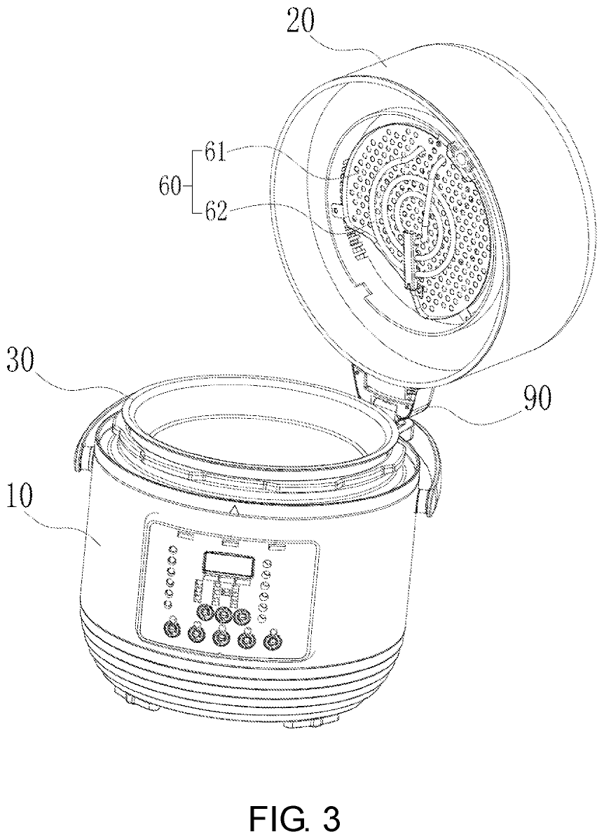

As shown in FIG. 3, the air fryer assembly comprises a heating assembly 60 and a wind power assembly 50, and the heating assembly 60 is cooperated with the wind power assembly 50 to act on a space defined by the cooker cover 20 and the cooker body 10. The heating assembly 60 provides heat and the wind power assembly 50 realizes the flowing of hot air. The wind power assembly 50 collaborates with the heating assembly 60. When the cooker cover 20 provided with the air fryer assembly is connected with the cooker body 10, the flowing of hot air is formed in the cooker body 10. The hot air is used to bake the food to realize the air fryer function of the multifunctional cooker.

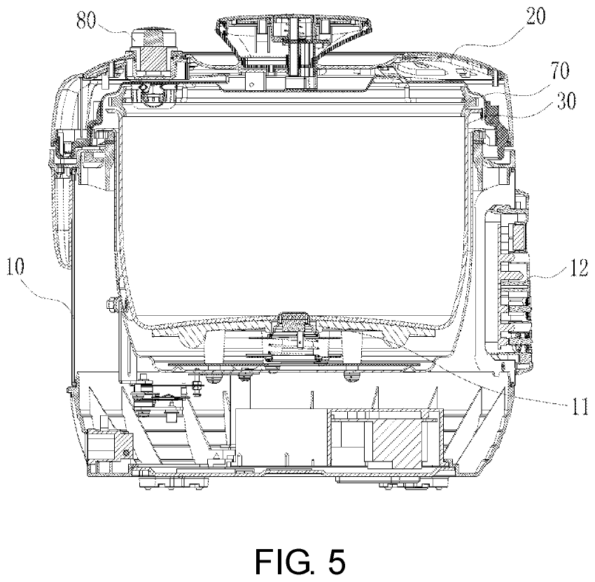

As shown in FIG. 5, the cooker cover 20 with the pressure cooker assembly is used to be connected with the cooker body 10. The pressure cooker assembly is provided with a pressure limiting valve assembly 80 and a seal housing 70 which are connected with the cooker cover 20, and the sealing housing 70 realizes the sealing for the cooker body 10 when the cooker cover 10 is connected with the cooker body 20. A pressure is released by the pressure limiting valve assembly 80 when the pressure in the cooker body 10 exceeds a threshold value, thereby realizing the adjustment to the pressure in the cooker body 10.

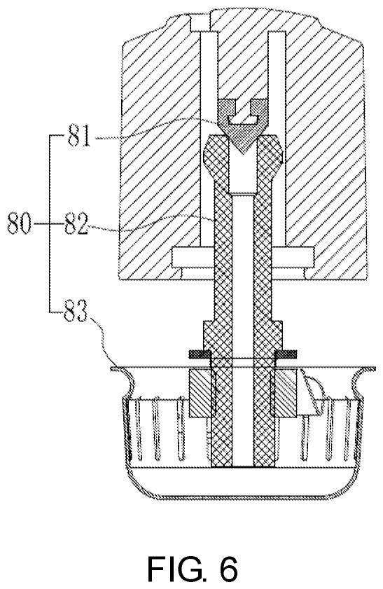

As shown in FIG. 6, in the present embodiment, the pressure limiting valve assembly 80 is provided with an exhaust pipe 82 penetrating the cooker cover 20. Both ends of the exhaust pipe 82 are connected with a protective casing 83 and a valve 81 respectively. The valve 81 closes the exhaust pipe 82. When the pressure of the cooker body 10 exceeds the threshold, the valve 81 is opened, and the pressure in the cooker body 10 is released through the exhaust pipe 82. The protective casing 83 prevents the exhaust pipe 82 from being blocked by the food in the cooker body.

In the present embodiment, the cooker body 10 is provided with an inner pot 30 and a frying basket 40. When the cooker cover 20 provided with the air fryer assembly is connected with the cooker body 10, the frying basket 40 is used to be cooperated with the cooker cover 20; when the cooker cover 20 provided with the pressure cooker assembly is connected with the cooker body 10, the inner pot 30 is used to be cooperated with the cooker cover 20.

### Embodiment 2

The present embodiment is similar to embodiment 1, except that in the present embodiment, the multifunctional cooker is provided with two cooker covers 20, and all of the cooker covers 20 are connected with the cooker body 10.

The cooker cover 20 connected with the cooker body 10 is turned over and opened with respect to the cooker body 10, and the cooker cover does not need to be removed and placed on another place. And then other cooker cover 20 is used to be connected with and close the cooker body 10. Through through the cooperation between the cooker covers 20 provided with different assemblies and the cooker body 10, the function switch of the multifunctional cooker between the air fryer function and the pressure cooker function is realized and the purpose of one cooker with multiple functions is realized.

### Embodiment 3

The present embodiment is similar to embodiment 1, except that in the present embodiment, the multifunctional cooker is provided with two cooker covers 20. One cooker cover 20 is provided with an air fryer assembly and connected with the cooker body 10 by a hinge assembly 90. Another cooker cover 20 is provided with a pressure cooker assembly and is arranged separately with respect to the cooker body 10.

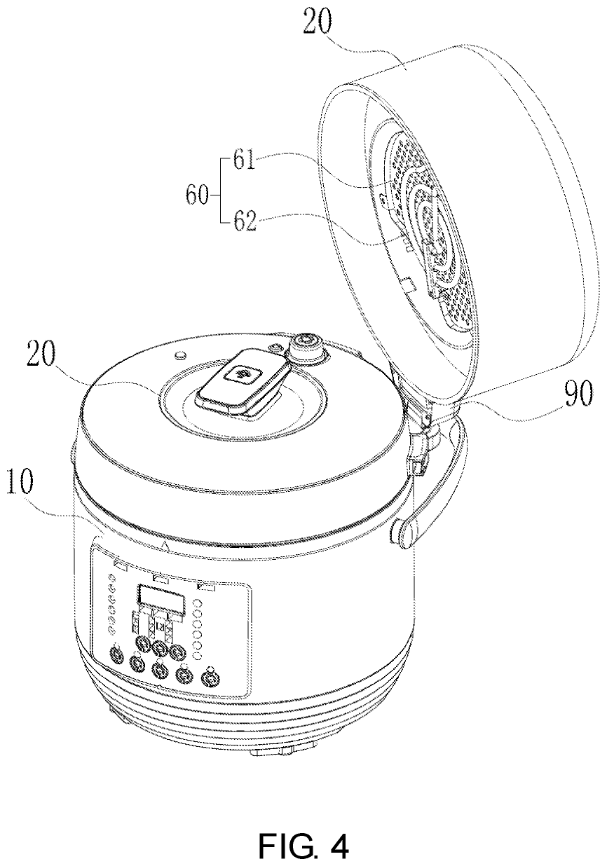

As shown in FIG. 4, the cooker cover 20 provided with the air fryer assembly is connected with the cooker body and the air fryer function of the multifunctional cooker is realized. The cooker cover 20 provided with the air fryer assembly is turned over and opened with respect to the cooker body 10, and the cooker cover does not need to be removed and placed on another place. And then the cooker cover 20 provided with the pressure cooker assembly is used to be connected with and close the cooker body 10. The function switch of the multifunctional cooker between the air fryer function and the pressure cooker function is realized and the purpose of one cooker with multiple functions is realized.

The two cooker covers 20 are connected alternately with the cooker body 10 to realize the function switch of the multifunctional cooker between the air fryer function and the pressure cooker function.

As shown in FIG. 3, a heat insulation member 61 is provided between the wind power assembly 50 and the wind power assembly 60. The heat insulation member 61 is a heat insulation plate, and the heat insulating member 61 isolates the wind power assembly 60 and the wind power assembly 50, so as to prevent the high temperature of the heating assembly 60 from damaging the wind power assembly 50.

As shown in FIG. 3, in the present embodiment, the heating assembly 60 is a heating tube 62, and the heating tube 62 is arranged to be bent and tortuous to increase the heating area and provide a good heating effect. The wind power assembly 50 is provided with a drive member 51 and a fan 52. The drive member 51 is a motor and the drive member 51 is connected with the fan 52. The fan 52 acts on the heating assembly 60 to realize the flowing of hot air.

As shown in FIG. 3 and FIG. 5, the cooker body 10 is provided with a base assembly comprising a heating base 11 and a control module 12. The heating base 11 is controlled by the control module 12, and the base assembly is cooperated with the cooker cover 20 provided with the pressure cooker assembly, so as to realize the heating function.

As shown in FIG. 3, a hinge assembly 90 comprises a hinge cover 91, a hinge mount 93 and a hinge pin 92. The hinge cover 91 is rotatably connected with a hinge mount 93 by a hinge pin 92. The hinge cover 91 and the hinge mount 93 are connected with the cooker cover 20 and the cooker body 10 respectively and a rotatable connection between the cooker cover 20 and the cooker body 10 is realized.

Similarly, it may also be arranged that the cooker cover 20 provided with the pressure cooker assembly is connected with the cooker body by the hinge assembly, and that cooker cover 20 provided with the air fryer assembly is arranged separately with respect to the cooker body, thereby realizing the switching of the functions of the multifunctional cooker.

Obviously, the above-mentioned embodiments of the present invention are merely examples for clearly illustrating the present invention, rather than limiting the embodiments of the present invention. For those skilled in the art, other different forms of changes or variations can be made based on the above description. There is no need to exhaustively list all implementations. Any modification, equivalent replacement and improvement made within the spirit and principle of the present invention should be included in the protection scope of the claims of the present invention.

1. A multifunctional cooker, comprising a cooker body and cooker covers, wherein number of the cooker covers are at least two, at least one of the cooker covers is provided with an air fryer assembly, at least one of the cooker covers is provided with a pressure cooker assembly, and at least one of the cooker covers is connected with the cooker body.

2. The multifunctional cooker according to claim 1, wherein at least one of the cooker covers is arranged separately with respect to the cooker body.

3. The multifunctional cooker according to claim 1, wherein the at least two cooker covers are two cooker covers, one of the two cooker covers is provided with the air fryer assembly, and the other one of the two cooker covers is provided with the pressure cooker assembly.

4. The multifunctional cooker according to claim 3, wherein the cooker cover provided with the air fryer assembly is connected with the cooker body, and the cooker cover provided with the pressure cooker assembly is arranged separately with respect to the cooker body.

5. The multifunctional cooker according to claim 3, wherein the cooker cover provided with the pressure cooker assembly is connected with the cooker body, and the cooker cover provided with the air fryer assembly is arranged separately with respect to the cooker body.

6. The multifunctional cooker according to claim 1, wherein the cooker cover is rotatably connected with the cooker body by a hinge assembly, and the hinge assembly comprises a hinge cover connected with the cooker cover, the hinge cover is connected with a hinge mount by a hinge pin, and the hinge mount is connected with the cooker body.

7. The multifunctional cooker according to claim 1, wherein the air fryer assembly comprises a heating assembly and a wind power assembly, the heating assembly is cooperated with the wind power assembly to act on a space defined by the corresponding cooker cover and the cooker body; a heat insulation member is provided between the heating assembly and the wind power assembly; the heating assembly is a heating tube and the wind power assembly comprises a drive member and a fan.

8. The multifunctional cooker according to claim 1, wherein the pressure cooker assembly comprises a pressure limiting valve assembly and a seal housing which are connected with the corresponding cooker cover, the cooker body is sealed by the sealing housing when the cooker cover is connected with the cooker body, a pressure is released by the pressure limiting valve assembly when the pressure in the cooker body exceeds a threshold value; and the pressure limiting valve assembly comprises an exhaust pipe, a protective casing and a valve, the exhaust pipe penetrates the cooker cover, and both ends of the exhaust pipe are connected with the protective casing and the valve respectively.

9. The multifunctional cooker according to claim 1, wherein the cooker body is provided with a base assembly comprising a heating base and a control module, the heating base is controlled by the control module, and the base assembly is cooperated with the cooker cover provided with the pressure cooker assembly, so as to realize a heating function.

10. The multifunctional cooker according to claim 1, wherein the cooker body is provided with an inner pot and a frying basket, the inner pot is cooperated with the cooker cover provided with the pressure cooker assembly, and the frying basket is cooperated with the cooker cover provided with the air fryer assembly.
